(19) United States
(12) Patent Application Publication
(10) Pub. No.: US 2025/0115708 A1
(43) Pub. Date: Apr. 10, 2025

(54) CRYSTALLINITY ADJUSTMENT FOR PET SOLID-STATE POLYMERIZATION PROCESS

(71) Applicant: UOP LLC, Des Plaines, IL (US)

(72) Inventors: Raymond Shih, Kildeer, IL (US); Gianfranco Ballarin, Chicago, IL (US); Mulugeta Kebede, Tortona (IT)

(21) Appl. No.: 18/762,991

(22) Filed: Jul. 3, 2024

Related U.S. Application Data
(60) Provisional application No. 63/587,732, filed on Oct. 4, 2023.

(51) Int. Cl. C08G 63/88; B01J 19/24

(52) U.S. Cl. CPC C08G 63/88; B01J 19/24

(57) ABSTRACT

An apparatus for producing solid crystallized polymer particles. The apparatus includes a precrystallizer followed by a static vessel. The crystallinity of the polyester is increased in the static vessel compared to the crystallinity of the polyester from the precrystallizer or the single crystallizer. Inert gas is fed to the static vessel to remove oligomers and fines from the chip and assist with chip mobility. It can optionally include a single crystallizer. The static vessel can replace one or both of the crystallizers in a conventional polyester process. A method for making polyester particles is also described.

### RELATED APPLICATIONS

This application claims priority to U.S. Provisional Patent Application Ser. No. 63/587,732, filed on Oct. 4 2023, the entirety of which is incorporated herein by reference.

### BACKGROUND

The PET solid-state polymerization (SSP) process is designed to upgrade PET from a melt-phase polymerization process to produce high molecular weight material. More than 90% of the PET SSP product is for bottle-grade PET resin. The bottle-grade PET resin applications include mineral water, carbonated soft drink (CSD), and hot-fill bottles.

The SSP process is accomplished by heating the polymer in solid-chip form at a temperature above the polymer's glass transition temperature (80° C.) but below its melting point (about 240° C.). In a conventional SSP process, a fluidized bed heater and two or more mechanical crystallizers are used to increase the crystallinity of the PET at about 45% or higher. The SSP process is typically conducted in an inert-gas environment such as nitrogen to prevent oxidative degradation of the polymer at the elevated temperature.

Molecular weight increase by joining polymer molecules can take place by either of two primary reactions, transesterification and esterification. These reactions are commonly referred to as polycondensation reactions. After combining two PET molecules, the transesterification reaction yields one molecule of ethylene glycol (EG), while esterification yields one molecule of water for every PET molecule.

PET exists in either an amorphous or a semi-crystalline state. The form of the crystals depends on whether the material is oriented (mechanically strain-induced crystallinity) or produced by heating the amorphous material above its glass transition temperature.

Before the PET becomes highly crystallized, the mobility or melting of the PET molecules may result in fusing between two or more PET chips, or “stickiness”. Lower crystallinity and higher temperature are major factors contributing to agglomeration in the reactor. There are additional factors that can lead to tendency to stickiness, such as carboxyl content, comonomer, oligomer and fines, chips property, maximum stress in the reactor, etc.

To reduce the sticky tendency in the reactor, the conventional SSP process utilizes mechanical crystallizers to provide time for crystallization while keep chips mobile to minimize the chance of the chips fusing. Typical crystallizers include screw-type, mechanical mixing paddle-shaft, paddles, vibration beds, and moving beds. Such machinery is usually expensive, difficult to maintain, and consumes large amounts of energy.

Therefore, there is a need to provide a lower cost, less energy intensive SSP process that minimizes chip fusion.

### BRIEF DESCRIPTION OF THE DRAWINGS

FIG. 1 is a diagram of a conventional SSP process.

FIG. 2 is a diagram of one embodiment of a process of the present invention.

FIG. 3 is a diagram of another embodiment of a process of the present invention.

FIG. 4A is a diagram of one embodiment of the internal structural of a static vessel.

FIG. 4B is a top plan view of the embodiment of FIG. 4A.

FIG. 5 is a graph of the cohesive strength as a function of the consolidation pressure of the PET chips.

### DESCRIPTION

This present invention meets this need by fully or partially replacing the expensive crystallizers with a small static vessel. The static vessel does not contain moving parts, unlike the crystallizers, which reduces the cost of the machinery and maintenance, as well as reducing the energy used in the process. Through various vessel designs, the static vessel reduces the maximum stress at the chips to minimize the chance of agglomeration within the vessel even at lower crystallinity. Such vessel design changes may include cone angle, surface smoothness, inert gas flow, vessel internal design, cross-sectional area change, or combinations thereof.

The process can be used for a variety of polyesters. Suitable polyesters include, but are not limited to, polyester terephthalate (PET), polytrimethylene terephthalate (PTT), polybutylene terephthalate (PBT), polytrimethylene naphthalate (PNT), polycyclohexyl terephthalate (PCT), polyethylene nalphthalate (PEN), polyethylene furanoate (PEF), or combinations thereof.

For ease of discussion, PET will be used as the polyester in the following discussion. Those of skill in the art will understand the invention is not limited to PET.

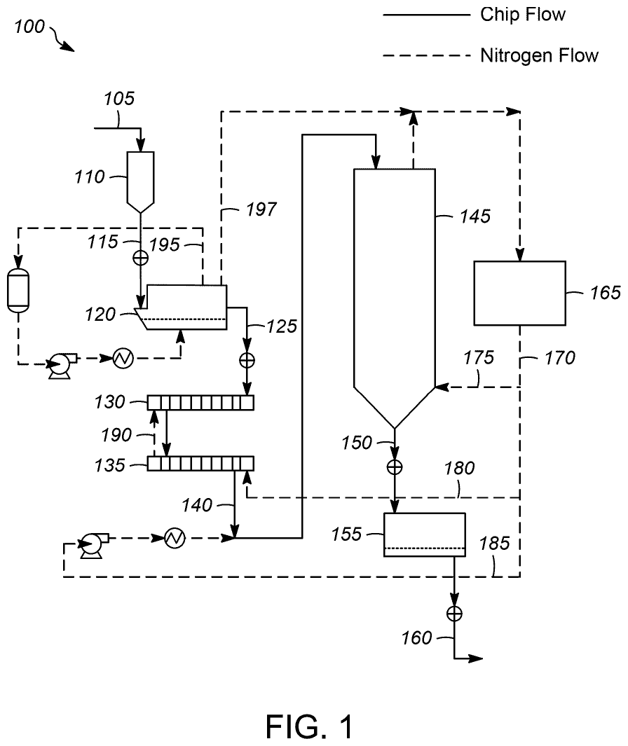

As shown in FIG. 1, in a conventional SSP process 100, the PET feed stream 105 is sent to a surge vessel 110. The PET feed stream 115 exiting the surge vessel 110 has a crystallinity in the range of 0 to 35% depending on the upstream pellitizing mechanism.

The PET feed stream 115 from the surge vessel 110 is sent to the precrystallizer (such as a fluidized bed heater) 120 where it is heated to a temperature above the glass transition temperature, but below the melting point. The heated PET feed stream 125 exiting the precrystallizer 120 has a crystallinity in the range of 35 to 40%.

The heated PET feed stream 125 is sent to a first crystallizer 130, and on to the second crystallizer 135. The crystallinity of the partially crystallized PET feed stream 140 exiting the second crystallizer 135 is in the range of 45% or more.

The partially crystallized PET feed stream 140 is sent to the SSP reactor 145 where the crystallinity is increased further to a range of 50% or more. The PET stream 150 exiting the SSP reactor is cooled in a cooler 155, and the PET product stream 160 is recovered.

The inert gas purification system 165 removes impurities by oxidation and removes water. The purified inert gas stream 170 is divided into three parts 175, 180, 185. Inert gas stream 175 is sent to the SSP reactor 145. Inert gas stream 180 is sent to the second crystallizer 135. The partially crystallized PET feed stream 140 from the second crystallizer 135 is sent to the SSP reactor 145 using inert gas stream 185 as the lift gas. Inert gas stream 190 from the second crystallizer 135 is sent to the first crystallizer 130, and then to the precrystallizer 120. Recycle inert gas stream 195 from the precrystallizer 120 is recycled to the precrystallizer 120. A second inert gas stream 197 from the precrystallizer 120 is sent to the inert gas purification system 165.

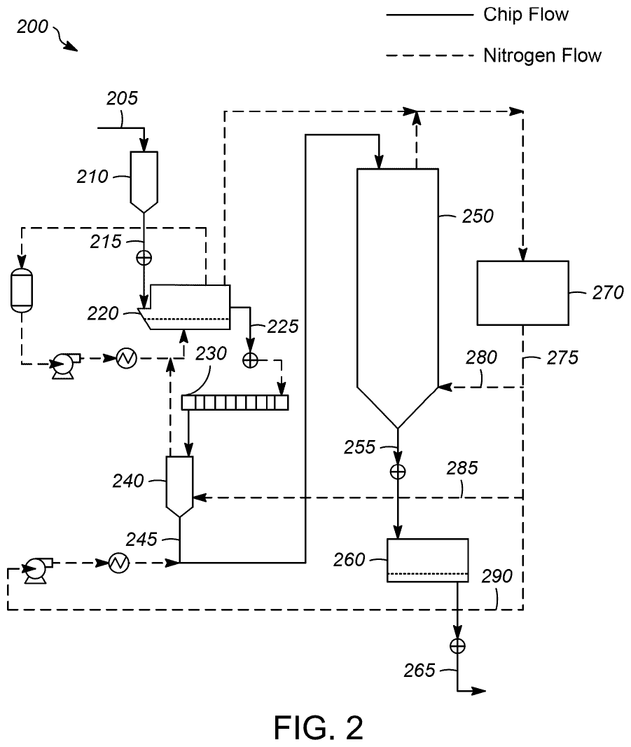

In the embodiment shown in FIG. 2, a single crystallizer is followed by a static vessel to further crystallize the PET chips and heat up the chips before the SSP reactor.

In the process 200 of FIG. 2, the PET feed stream 205 is sent to a surge vessel 210. The PET feed stream 215 exiting the surge vessel 210 has a crystallinity in the range of 0 to 35%.

The PET feed stream 215 from the surge vessel 210 is sent to the precrystallizer 220 where it is heated to a temperature above the glass transition temperature, but below the melting point. Suitable precrystallizers 220 include, but are not limited to, fluidized bed heaters, stirring/agitated heaters (vessels with agitation which act as heaters), batch heaters, heat exchangers, or combinations thereof. The heated PET feed stream 225 exiting the precrystallizer 220 has a crystallinity in the range of about 35 to 40%.

There can be a valve (not shown) between the surge vessel 210 and the precrystallizer 220 in order to maintain the consistent flow of solids and to prevent the unimpeded passage of gases between vessels.

The heated PET feed stream 225 is sent to a single crystallizer 230. The crystallinity of the partially crystallized PET feed stream 235 exiting the single crystallizer 230 is in the range of 37 to 42%.

The partially crystallized PET feed stream 235 from the single crystallizer 230 is sent to the static vessel 240 where the crystallinity is increased to a range of 45% or more.

The PET stream 245 from the static vessel 240 is sent to the SSP reactor 250 where the crystallinity is increased further to a range of 50% or more. The PET stream can be conveyed to the SSP reactor 250 using any type of conveying system. Suitable conveying systems include, but are not limited to, gravity fed conveying systems and pneumatic conveying systems.

The PET stream 255 exiting the SSP reactor is cooled in a cooler 260 to a temperature of 60° C. or less, and the PET product stream 265 is recovered.

The process includes an inert gas purification system 270. A fresh inert gas stream 275 exits the inert gas purification system 270. One portion 280 of the fresh inert gas stream 275 is sent to the SSP reactor 250. A second portion 285 is sent to the static vessel 240 to remove oligomers and fines from the chip and assist with chip mobility. There are one or more inlets to the static vessel 240 for the second portion 285 of the fresh inert gas stream 275. The inlets can be located at various elevations of the static vessel 240. A third portion 290 of the fresh inert gas stream 275 is used to convey the PET stream 245 from the static vessel 240 to the SSP reactor 250.

An inert gas stream 295 from the static vessel 240 is sent to the precrystallizer 220 which assists in fluidizing the flow and removes fines and oligomers. A recycle inert gas stream 300 from the precrystallizer 220 is recycled to the precrystallizer 220. A second inert gas stream 305 from the precrystallizer 220 is sent to the inert gas purification system 270.

Depending on the crystallinity of the feed from the precystallizer 220, the single crystallizer 230 is optional. In either case, the heated PET feed stream 225 from the precrystallizer 220 would go the static vessel 240.

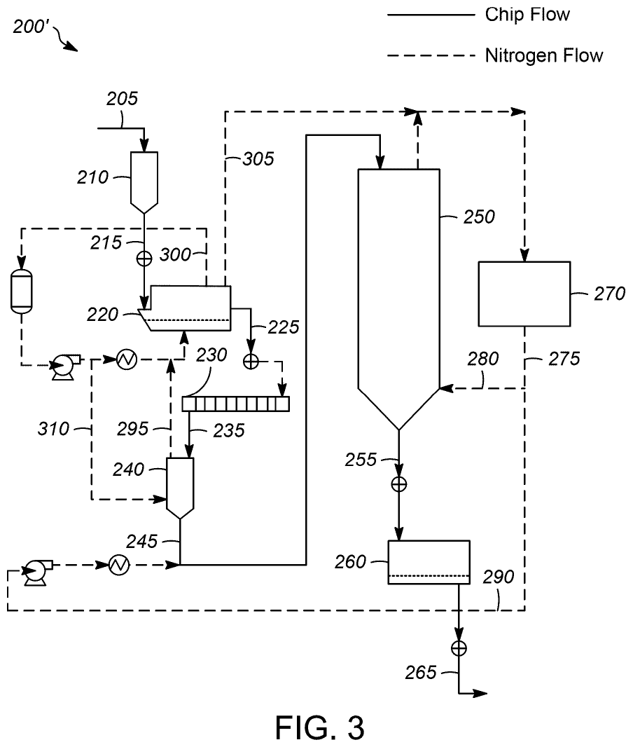

FIG. 3 is a similar design, but the inert gas flow is different. In this process 200′, a portion 280 of fresh inert gas stream 275 is sent to the SSP reactor, and a portion 290 is used to convey the PET stream 245 from the static vessel 240 to the SSP reactor 250. The inert gas stream 295 from the static vessel 240 is sent to the precrystallizer 220. The recycle inert gas stream 300 from the precrystallizer 220 is recycled to the precrystallizer 220. The second inert gas stream 305 from the precrystallizer 220 is sent to the inert gas purification system 270.

However, fresh inert gas is not sent to the static vessel 240. Instead, a portion 310 of the recycle inert gas stream 300 is sent to the static vessel 240.

Recycling the inert gas reduces the load on the inert gas purification system 270. While recycled inert gas may be acceptable for increasing the crystallinity, it may allow oligomer and dust to reenter the system. Fresh inert gas would not present this problem.

The static vessel typically takes the form of a hopper, with the most significant stress concentration occurring at the juncture of the cylinder and cone sections. The mass in the cylinder section of the static vessel should be controlled to limit the stress at the tangent line. The fusion of the PET chips in a hopper is mainly governed by temperature, crystallinity, and stress on the chips. It can also be de-risked if there is sufficient motion among particles. Granular flow in a silo or a hopper can be modeled using appropriate software, for example DEM (Discrete element method model). The static vessel was modeled using common PET physical properties, a 900 ton/day unit, a static vessel 4 m in diameter, and a residence time of 0.5 hour and 1 hour for each case. The simulation showed that the maximum stress is very low at 7 and 11 kPa for each case due to lower level required. This is significantly lower than typical reactor vessel. In addition, high radial velocity was recorded, indicating strong particle movement between PET chips in bottom cylinder and cone sections. Reducing stress within the silo minimizes the physical deformation of PET particles and their contact zones. The dynamics of particle movement exert forces that disrupt any potential bonding, thereby diminishing the likelihood of particle clumping. In addition, the conveying hot lift gas after the static vessel will add additional force to break up any fused chips formed, and the static vessel can be run at lower temperature if necessary. These measures collectively decrease the probability of agglomeration inside the container.

The residence time in the static vessel is typically in the range of 30 minutes to 6 hours, or 30 minutes to 5 hours, or 30 minutes to 4 hours, or 30 minutes to 3 hours, or 30 minutes to 2 hours, or 30 minutes to 1 hour.

To maintain chip mobility, strategies such as internal structural adjustments or alterations in cross-sectional profiles can be employed. The objective is to guarantee unhindered movement of chips throughout the vessel. By fine-tuning these parameters, the PET chips can attain the optimal level of crystallinity without any adhesive tendencies.

Achieving the ideal degree of crystallinity is contingent upon various factors within the actual PET composition, including components like copolymer presence, catalyst influence, and carboxyl-hydroxyl content. The choice of analytical techniques also plays a pivotal role, such as X-ray, ATR-FTIR, DSC, gravity-based methods, or measuring PET density by injecting helium gas for volume and measuring the weight. As a general approximation, the targeted level of optimal crystallinity is typically around 45% before the reactor.

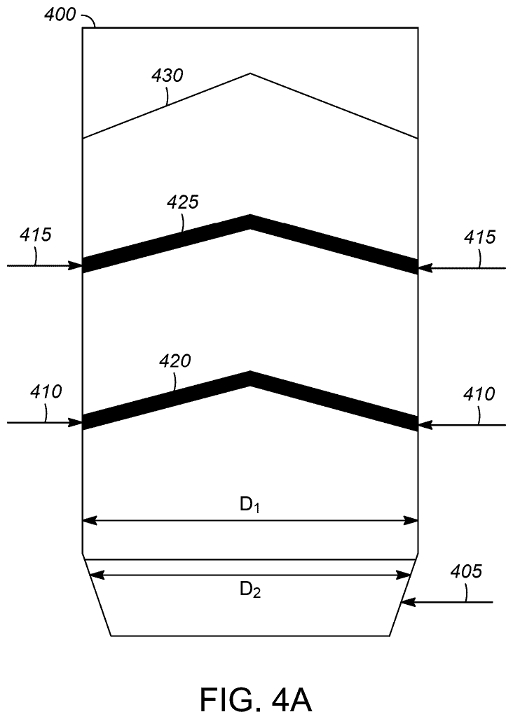

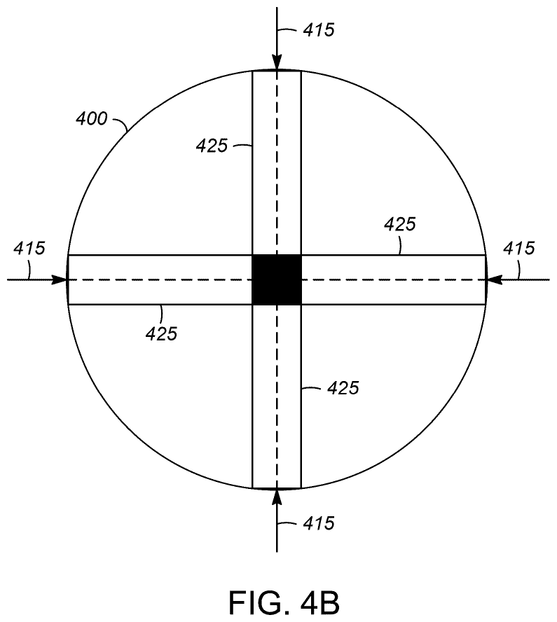

FIGS. 4A and 4B5 are illustrate one design of the internal structure of a static vessel 400. The inert gas flow in the static vessel is designed to ensure even flow across the reactor at each elevation to ensure efficient removal of oligomers and to balance the temperature from the heat of crystallization.

The static vessel 400 has a cone section with a diameter D1 and a cone section where the diameter D2 is less than diameter D1. There are inert gas inlets 405, 410, 415 at three different positions on the static vessel 400. There can be one or more positions on the static vessel 400 at which the inert gas inlets are located. At each position on the static vessel 400, there can be one or more inert gas inlets, 405, 410, 415. FIG. 4B shows four inert gas inlets 415.

There are internal baffles 420, 425, 430 which are higher in the middle of the static vessel 400 than at the sides as shown in FIG. 4A. The baffle facilitates movement among the PET chips by leveraging the change in cross-sectional area. The internal baffles 420, 425, 430 can be solid. Alternatively, they can be perforated pipes connected to the inert gas inlets so that the inert gas can flow through them.

### EXAMPLES

### Example 1

A techno-economic analysis was made to an existing case of 550 ton/d PET solid-state polymerization unit. The simulation was done through proprietary software. It showed 8% saving in overall capital cost, and 6% saving in utilities. This does not include any reduction in maintenance work as a result of having only one (or no) crystallizer.

| | Electrical | HTF Energy |
|---|---|---|
| | (kWH/ton) | (kWH/ton) |
| Conventional SSP Process | 74 | 51 |
| with two crystallizers | | |
| SSP Process with single | 68 | 48 |
| crystallizer and static vessel | | |

### Example 2

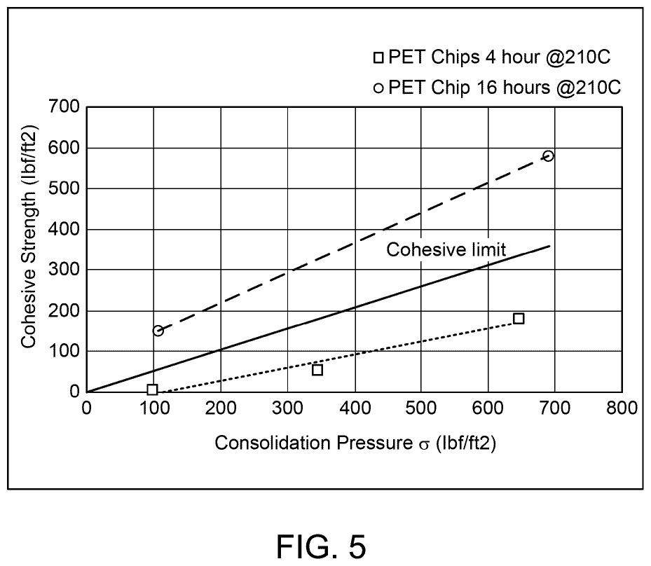

A standard PET feed was subjected to solid-state polymerization and subsequently tested on a shear tester to assess its cohesive strength under varying consolidation pressures. The samples underwent continuous exposure to nitrogen flow at a temperature of 210° C. for either 4 or 16 hours, effectively replicating real-world vessel conditions. The results are illustrated in FIG. 5.

This comparison evaluated the performance of PET samples with similar intrinsic viscosity and crystallinity. The findings demonstrated that the samples tested for 4 hours under similar load exhibited lower cohesive strength when compared to the samples tested for 16 hours. Consequently, in a smaller vessel, the tendency to agglomeration is significantly less.

### Specific Embodiments

While the following is described in conjunction with specific embodiments, it will be understood that this description is intended to illustrate and not limit the scope of the preceding description and the appended claims

A first embodiment of the invention is an apparatus for producing solid crystallized polymer particles comprising a precrystallizer for heating a polyester feed produced from a melt-phase polyester polymerization plant with a first inert gas, to obtain a level of crystallization in the range of 35 to 40%; a static vessel connected to an outlet of the precrystallizer, the static vessel having a countercurrent flow of a second inert gas to obtain a level of crystallization greater than or equal to 45%, the static vessel having a residence time of 30 minutes to 6 hours; and an SSP reactor vessel connected to the static vessel, the SSP reactor having a countercurrent flow of a third inert gas. An embodiment of the invention is one, any or all of prior embodiments in this paragraph up through the first embodiment in this paragraph further comprising a single crystallizer located between the outlet of the precrystallizer and an inlet to the static vessel to obtain a level of crystallization in the range of 37 to 42%. An embodiment of the invention is one, any or all of prior embodiments in this paragraph up through the first embodiment in this paragraph wherein the static vessel has a first inert gas inlet at a first height and a second inert gas inlet at a second height above the first height. An embodiment of the invention is one, any or all of prior embodiments in this paragraph up through the first embodiment in this paragraph wherein the static vessel has the residence time of 30 minutes to 1 hour. An embodiment of the invention is one, any or all of prior embodiments in this paragraph up through the first embodiment in this paragraph wherein the static vessel comprises internal baffles or wherein the static vessel has a change cross sectional size, or both. An embodiment of the invention is one, any or all of prior embodiments in this paragraph up through the first embodiment in this paragraph wherein the static vessel comprises a plurality of perforated pipes connected to a plurality of inert gas inlets. An embodiment of the invention is one, any or all of prior embodiments in this paragraph up through the first embodiment in this paragraph wherein the first inert gas, or the second inert gas, or the third inert gas, or combinations thereof is nitrogen. An embodiment of the invention is one, any or all of prior embodiments in this paragraph up through the first embodiment in this paragraph wherein the precrystallizer comprises a fluid bed heater. An embodiment of the invention is one, any or all of prior embodiments in this paragraph up through the first embodiment in this paragraph further comprising a surge vessel for importing the polyester feed, an outlet of the surge vessel connected to an inlet of the precrystallizer. An embodiment of the invention is one, any or all of prior embodiments in this paragraph up through the first embodiment in this paragraph further comprising a conveying system connecting the static vessel to the SSP reactor vessel.

A second embodiment of the invention is a process for making polyester particles comprising providing a polyester feed stream; heating the polyester feed stream in a precrystallizer with a first inert gas to obtain a level of crystallization in the range of 35 to 40% and form a heated polyester stream; passing the heated polyester stream to a static vessel having a countercurrent flow of a second inert gas to obtain a second polyester stream having a level of crystallization of greater than or equal to 45%; and passing the second polyester stream to an SSP to increase the crystallinity of the second polyester stream to a level of crystallinity greater than or equal to 50%. An embodiment of the invention is one, any or all of prior embodiments in this paragraph up through the second embodiment in this paragraph further comprising partially crystallizing the heated polyester stream in a single crystallizer to obtain a level of crystallization in the range of 37 to 42% before passing the heated polyester stream to the static vessel. An embodiment of the invention is one, any or all of prior embodiments in this paragraph up through the second embodiment in this paragraph further comprising passing a third inert gas through the SSP reactor in a countercurrent flow. An embodiment of the invention is one, any or all of prior embodiments in this paragraph up through the second embodiment in this paragraph wherein third inert gas comprises nitrogen. An embodiment of the invention is one, any or all of prior embodiments in this paragraph up through the second embodiment in this paragraph wherein the first inert gas, or the second inert gas, or combinations thereof comprises nitrogen. An embodiment of the invention is one, any or all of prior embodiments in this paragraph up through the second embodiment in this paragraph wherein at least a portion of the second inert gas in the static vessel is recycled inert gas. An embodiment of the invention is one, any or all of prior embodiments in this paragraph up through the second embodiment in this paragraph wherein the static vessel has a residence time of 30 minutes to 6 hours. An embodiment of the invention is one, any or all of prior embodiments in this paragraph up through the second embodiment in this paragraph wherein the static vessel has a residence time of 30 minutes to 1 hour. An embodiment of the invention is one, any or all of prior embodiments in this paragraph up through the second embodiment in this paragraph further comprising passing the polyester feed stream to a surge vessel before heating the polyester feed stream. An embodiment of the invention is one, any or all of prior embodiments in this paragraph up through the second embodiment in this paragraph wherein the static vessel comprises internal baffles or wherein the static vessel has a change cross sectional size, or both. An embodiment of the invention is one, any or all of prior embodiments in this paragraph op through the second embodiment in this paragraph wherein the static vessel comprises a plurality of perforated pipes connected to a plurality of inert gas inlets.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An apparatus for producing solid crystallized polymer particles comprising:
a precrystallizer for heating a polyester feed produced from a melt-phase polyester polymerization plant with a first inert gas, to obtain a level of crystallization in the range of 35 to 40%;
a static vessel connected to an outlet of the precrystallizer, the static vessel having a countercurrent flow of a second inert gas to obtain a level of crystallization greater than or equal to 45%, the static vessel having a residence time of 30 minutes to 6 hours; and
an SSP reactor vessel connected to the static vessel, the SSP reactor having a countercurrent flow of a third inert gas.

2. The apparatus of claim 1 further comprising:
a single crystallizer located between the outlet of the precrystallizer and an inlet to the static vessel to obtain a level of crystallization in the range of 37 to 42%.

3. The apparatus of claim 1 wherein the static vessel has the residence time of 30 minutes to 1 hour.

4. The apparatus of claim 1 wherein the static vessel comprises internal baffles or wherein the static vessel has a change cross sectional size, or both.

5. The apparatus of claim 1 wherein the static vessel comprises a plurality of perforated pipes connected to a plurality of inert gas inlets.

6. The apparatus of claim 1 wherein the first inert gas, or the second inert gas, or the third inert gas, or combinations thereof is nitrogen.

7. The apparatus of claim 1 further comprising:
a surge vessel for importing the polyester feed, an outlet of the surge vessel connected to an inlet of the precrystallizer.

8. The apparatus of claim 1 further comprising:
a conveying system connecting the static vessel to the SSP reactor vessel.

9. A process for making polyester particles comprising:
providing a polyester feed stream;
heating the polyester feed stream in a precrystallizer with a first inert gas to obtain a level of crystallization in the range of 35 to 40% and form a heated polyester stream;
passing the heated polyester stream to a static vessel having a countercurrent flow of a second inert gas to obtain a second polyester stream having a level of crystallization of greater than or equal to 45%; and
passing the second polyester stream to an SSP to increase the crystallinity of the second polyester stream to a level of crystallinity greater than or equal to 50%.

10. The process of claim 9 further comprising:
partially crystallizing the heated polyester stream in a single crystallizer to obtain a level of crystallization in the range of 37 to 42% before passing the heated polyester stream to the static vessel.

11. The process of claim 9 further comprising:
passing a third inert gas through the SSP reactor in a countercurrent flow.

12. The process of claim 11 wherein third inert gas comprises nitrogen.

13. The process of claim 9 wherein the first inert gas, or the second inert gas, or combinations thereof comprises nitrogen.

14. The process of claim 9 wherein at least a portion of the second inert gas in the static vessel is recycled inert gas.

15. The process of claim 9 wherein the static vessel has a residence time of 30 minutes to 6 hours.

16. The process of claim 9 wherein the static vessel has a residence time of 30 minutes to 1 hour.

17. The process of claim 9 further comprising:
passing the polyester feed stream to a surge vessel before heating the polyester feed stream.

18. The process of claim 9 wherein the static vessel comprises internal baffles or wherein the static vessel has a change cross sectional size, or both.

19. The process of claim 9 wherein the static vessel comprises a plurality of perforated pipes connected to a plurality of inert gas inlets.
